(19) United States
(12) Patent Application Publication
(10) Pub. No.: US 2025/0068252 A1
(43) Pub. Date: Feb. 27, 2025

(54) VIRTUAL REALITY-BASED CONTROL METHOD AND APPARATUS, AND ELECTRONIC DEVICE

(71) Applicant: Beijing Zitiao Network Technology Co., Ltd., Beijing (CN)

(72) Inventors: Peipei WU, Beijing (CN); Xiaolin LI, Beijing (CN); Liyue JI, Beijing (CN); Wenhui ZHAO, Beijing (CN); Danyang WANG, Beijing (CN)

(21) Appl. No.: 18/724,600

(22) PCT Filed: Feb. 20, 2023
(86) PCT No.: PCT/CN2023/077218

§ 371 Date: Jun. 26, 2024

(30) Foreign Application Priority Data
Mar. 17, 2022 (CN) 20221026398.0

(51) Int. Cl. G06F 3/01; G06V 40/10; G06V 40/20

(52) U.S. Cl. CPC G06F 3/017; G06F 3/011; G06V 40/10; G06V 40/28

(57) ABSTRACT

The present disclosure relates to a virtual reality-based control method and apparatus, and an electronic device, and relates to the technical field of virtual reality. The method comprises: first monitoring image information captured by a camera for a user; identifying movement information of a target object in the image information; then, according to the movement information of the target object, displaying at least one interactive component model in a virtual reality space, and executing an interaction function event that is pre-bound to an interactive component model selected by the user. By means of applying the technical solution in the present disclosure, the technical problem that user control is easily influenced due to the buttons of an entity device being easily damaged can be effectively solved. A stronger technological sense can be brought to users, thereby enhancing the VR usage experience of users.

### CROSS-REFERENCE TO RELATED APPLICATION(S)

This application claims priority to Chinese Patent Application No. 202210263698.0 filed on Mar. 17, 2022 and entitled “VIRTUAL REALITY-BASED CONTROL METHOD AND APPARATUS, AND ELECTRONIC DEVICE”, the disclosure of which is incorporated herein by reference in its entirety.

### FIELD

The present disclosure relates to the technical field of virtual reality, and in particular, to a virtual reality-based control method and apparatus, and an electronic device.

### BACKGROUND

With the continuous development of the social productivity and science and technology, demands of various industries for the VR technology are increasingly strong. The VR technology has also made a tremendous progress and gradually become a new field of science and technology.

Currently, when users engage with virtual reality devices to experience VR effects, they typically control the device using physical buttons, such as those found in a settings menu, to perform common functions.

However, reliance on physical buttons poses durability concerns and can impede user control. Additionally, this approach often detracts from the overall technological immersion, thereby impacting the user experience.

### SUMMARY

In view of this, the present disclosure provides a virtual reality-based control method, an apparatus and an electronic device, with the primary goal of addressing shortcomings associated with existing control methods reliant on physical device buttons. These shortcomings include the susceptibility of physical buttons to damage, which can compromise user control, as well as the resultant diminished technological immersion, ultimately impacting the overall user experience.

In a first aspect, the present disclosure provides a virtual-reality control method, including: monitoring image information captured by a camera for a user: identifying movement information of a target object in the image information; and displaying, according to the movement information of the target object, at least one interactive component model in a virtual reality space, and performing an interaction function event that is pre-bound to an interactive component model selected by the user.

In a second aspect, the present disclosure provides a virtual-reality control apparatus, including: a monitoring unit configured to monitor image information captured by a camera for a user: an identifying unit, configured to identify movement information of a target object in the image information; and a displaying unit configured to display, according to the movement information of the target object, at least one interactive component model in a virtual reality space, and perform an interaction function event that is pre-bound to an interactive component model selected by the user.

In a third aspect, the present disclosure provides a computer-readable storage medium, having a computer program stored thereon, wherein the computer program, when run by a processor, implements the virtual reality-based control method described in the first aspect.

In a fourth aspect, the present disclosure provides an electronic device, including a storage medium, a processor, and a computer program stored on the above-mentioned and runnable on the processor, wherein the processor, when running the computer program, implements the virtual reality-based control method described in the first aspect.

By virtue of the above technical solutions, compared with the existing method for controlling through the buttons of the physical device, the virtual reality-based control method and apparatus, and the electronic device provided by the present disclosure provide an improved solution for VR control without the help of the buttons of the physical device. Specifically, on a VR device side, monitoring image information captured by a camera for a user is first monitored: movement information of a target object in the image information is then identified: then, according to the movement information of the target object, at least one interactive component model is displayed in a virtual reality space, and an interaction function event that is pre-bound to an interactive component model selected by the user is performed. By means of applying the technical solutions in the present disclosure, the technical problem that user control is easily affected due to the buttons of a physical device being easily damaged can be effectively solved. An improved technological immersion can be brought to users, thereby enhancing the VR usage experience of the users.

The above descriptions are only a summary of the technical solutions of the present disclosure. In order to be able to understand the technical means of the present application more clearly, the technical means can be implemented according to the content of the specification. Furthermore, in order to make the above and other objectives, features and advantages of the present disclosure more comprehensible, specific implementations of the present disclosure are exemplified below.

### BRIEF DESCRIPTION OF THE DRAWINGS

The drawings here are incorporated into and form part of the specification, showing the embodiments that comply with the present disclosure, and are used together with the specification to explain the principles of the present disclosure.

In order to describe the technical solutions in the embodiments of the present disclosure or in the related art more clearly, the following briefly introduces the accompanying drawings for describing the embodiments or the related art. Apparently, a person of ordinary skill in the art may still derive other drawings from the accompanying drawings without creative effort.

FIG. 1 shows a flowchart of a virtual reality-based control method provided according to embodiments of the present disclosure;

FIG. 2 shows a flowchart of another virtual reality-based control method provided according to embodiments of the present disclosure:

FIG. 3 shows a schematic diagram of an example displaying effect of an interactive component model in the form of a floating ball provided according to embodiments of the present disclosure:

FIG. 4 shows a schematic diagram of an example displaying effect of clicking an interactive component model provided according to embodiments of the present disclosure:

FIG. 5 shows a schematic diagram of an example displaying effect of an interactive component model in an application scenario provided according to embodiments of the present disclosure:

FIG. 6 shows a schematic diagram of an example displaying effect of a camera model in an application scenario provided according to embodiments of the present disclosure: and

FIG. 7 shows a schematic structural diagram of a virtual reality-based control apparatus provided according to embodiments of the present disclosure.

### DETAILED DESCRIPTION OF EMBODIMENTS

The embodiments of the present disclosure will be described in detail below with reference to the accompanying drawings. It should be noted that the embodiments of the present disclosure and features in the embodiments may be mutually combined without conflicts.

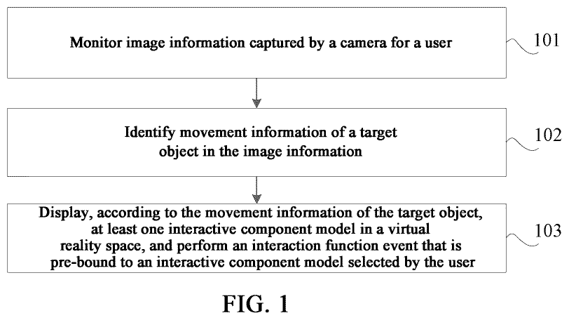

To improve the technical problems that due to an existing method for controlling through a button of a physical device, since the button of the physical device is easily damaged, control performed by a user may be easily affected, and this method also brings a user a poor technological sense, thereby affecting the user experience. This embodiment provides a virtual reality-based control method, as shown in FIG. 1, which can be applied to a VR device side. The method includes the following steps.

At Step 101, monitor image information captured by a camera for a user.

The camera can be connected to a VR device. When a user uses the VR device, the camera can take pictures of the user to obtain the image information. For example, the entire body of a user can be photographed, or specific parts of a user can be photographed. This can be specifically preset according to an actual need. This embodiment can obtain a control instruction of a user through image monitoring, such that VR control is performed without the help of a button of a physical device.

At Step 102, identify movement information of a target object in the image information.

The target object can be preset. Namely, a system of the VR device identifies which reference target in the image information to obtain the VR control instruction of the user. The target object may include: a hand of the user, and/or a leg of the user, and/or the head of the user, and/or the waist of the user, and/or the hip of the user, and/or a wearable device of the user, and/or the like.

In this embodiment, whether a preset condition of displaying an interactive component model is satisfied is determined based on the identified movement information of the target object. The interactive component model may be a component model for interaction. These interactive component models are respectively pre-bound with interaction function events, such that a user can achieve corresponding VR interaction functions by selecting the interactive component models. In this embodiment, a condition of displaying these interactive 10) component models may be preset for the target object for image monitoring. For example, if the hand of the user, and/or the leg of the user, and/or the head of the user, and/or the waist of the user, and/or the hip of the user, and/or a wearable device of the user, and/or the like satisfies a movement requirement, it can determine that the condition of displaying these interactive component models is satisfied, and then the interactive component models can be displayed in the virtual reality space. Based on subsequent movement information content of the target object, an interaction function event pre-bound to an interactive component model selected by the user may be performed, namely, a process shown in step 103 is performed.

At Step 103, display, according to the movement information of the target object, at least one interactive component model in a virtual reality space, and an interaction function event that is pre-bound to an interactive component model selected by the user is performed.

For example, three-dimensional spatial positions of these interactive component models are pre-bound to a three-dimensional spatial position of a virtual character of the user: then, a three-dimensional spatial position where these interactive component models are currently displayed is determined based on a real-time three-dimensional spatial position of the virtual character of the user, such that these interactive component models are displayed according to this position; and therefore, these interactive component models are presented in front of the virtual character of the user, such as presenting a plurality of interactive component models in the form of a wristband.

After the displaying of the interactive component model is awakened, in this embodiment, the image information captured for the user is continued to be monitored. By identifying the movement information of the hand of the user, and/or the leg of the user, and/or the head of the user, and/or the waist of the user, and/or the hip of the user, and/or the wearable device of the user, and/or the like in the image information, a target interactive component model selected by the user among the displayed interactive component models is determined, such that a corresponding VR interaction function may be achieved by performing the interaction function event pre-bound to the target interactive component model.

Compared with an existing method for controlling through buttons of a physical device, this embodiment provides an improved solution for performing VR control without the help of the button of the physical device. Specifically, the operation instruction of the user may be obtained by image monitoring. The improved solution of this embodiment can effectively improve the technical problem that user control is easily affected due to the buttons of the physical device being easily damaged. A stronger technological immersion may be brought to users, thereby enhancing the VR usage experience of the users.

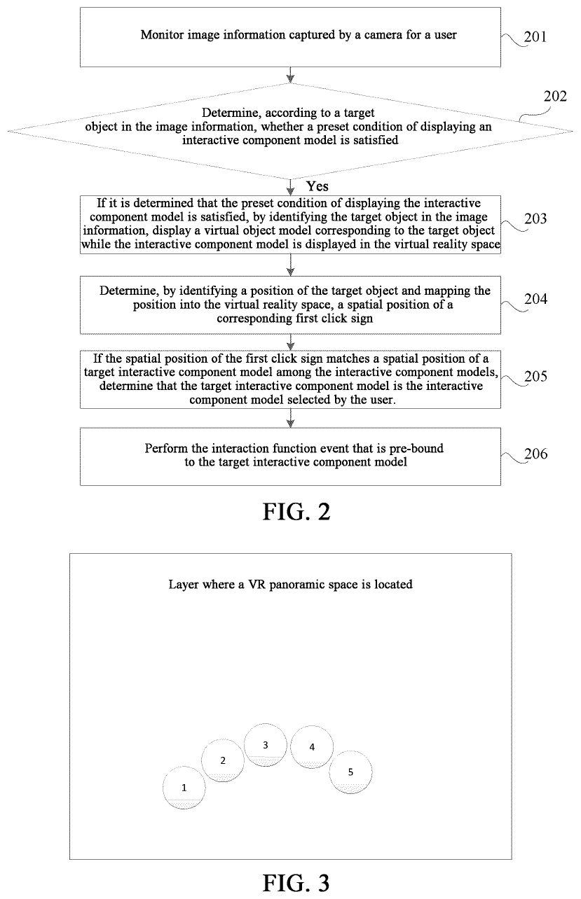

Further, as a refinement and extension of the above embodiment, to fully explain the specific implementation process of the method of this embodiment, this embodiment provides a specific method as shown in FIG. 2. The method includes the following steps.

At Step 201, monitor image information captured by a camera for a user.

At Step 202, determine, according to a target object in the image information, whether a preset condition of displaying an interactive component model is satisfied.

The target object including a hand of the user is taken as an example. Correspondingly optionally; Step 202 may specifically include: First, user gesture information in the image information is identified: whether the user gesture information matches preset gesture information is then determined; and if the user gesture information matches the preset gesture information, it is determined that the preset condition of displaying an interactive component model is satisfied. Thus, at least one interactive component model may be displayed in a virtual reality space. It may be further considered as a specific optional method for displaying the interactive component model in Step 103.

In this optional embodiment, preset gesture information for awakening the displaying of the interactive component model may be preset according to an actual need. For example, if a user makes a scissors gesture, it can trigger and awaken the displaying of the interactive component model, or different pieces of preset gesture information can awaken displaying of different interactive component models. This method for awakening the displaying of the interactive component model by identifying the gesture of the user can facilitate a user to perform control and improve the efficiency of performing VR control by a user.

As an example, determining whether the user gesture information matches preset gesture information may specifically include: if a lift amplitude of the hand of the user is greater than a preset amplitude threshold (which may be preset according to an actual need), it is determined that the user gesture information matches the preset gesture information.

For example, as shown in FIG. 3, based on an image identification technology, a user can raise a hand to awaken interactive component models in the form of a floating ball. Each floating ball represents a control function. The user can subsequently interact with others based on the floating ball functions. As shown in FIG. 3, floating balls 1, 2, 3, 4, and 5 can include from left to right in sequence: interactive component models such as “leaving the room”, “taking pictures”, “sending an emoji”, “sending on-screen comments”, and “menu”.

The target object includes a handheld device (such as a gamepad device) of the user is taken as an example. Correspondingly optionally, step 202 may specifically include: First, position information of the handheld device in the image information is identified: whether the position information of the handheld device complies with a preset position change rule is determined; and if the position information of the handheld device complies with the preset position change rule, it is determined that the preset condition of displaying an interactive component model is satisfied. Thus, at least one interactive component model may be displayed in a virtual reality space. It may be further considered as another specific optional method for displaying the interactive component model in step 103.

In this optional embodiment, the preset position change rule for the handheld device for awakening the displaying of the interactive component model may be preset according to an actual need. For example, if the handheld device of the user makes an action of drawing a circle in the air, it can trigger and awaken the displaying of the interactive component model, or different preset position change rules can awaken displaying of different interactive component models. This method of awakening the displaying of the interactive component model by identifying changes in the position of the handheld device of the user. Since the VR device can detect the handheld device of the user by using various sensors, the VR device can effectively assist in accurately determining whether the preset condition of awakening the displaying of the interactive component model, which facilitates a user to perform controlling and can effectively improve the accuracy of performing VR control by a user.

As an example, determining whether the position information of the handheld device complies with a preset position change rule may specifically includes: if a handheld device lifting amplitude is greater than a preset amplitude threshold (which may be preset according to an actual need), it is determined that the position information of the handheld device complies with the preset position change rule.

For example, similar to the example shown in FIG. 3, based on an image identification techniques, a user can lift a handheld device to awaken an interactive component model in the form of a floating ball. Each floating ball represents a control function. The user can subsequently interact with others based on the floating ball functions.

Further, for this embodiment, to prevent misoperation of a user (for example, when a user experiences a VR game, conventional gesture control behaviors in some games may awaken the displaying of the interactive component model and affect the user experience of the VR game), whether the preset condition of displaying the interactive component model is satisfied may be further determined by combining a scenario where the user is located and/or a region where a focus of the user is located.

For example, if the user is in a specific VR scenario, and/or if the focus of the user triggers the displaying of a VR controller, whether the preset condition of displaying the interactive component model is then determined according to the target object in the image information. Through this comprehensive determination method, a user may be prevented from awakening the displaying of the interactive component model by mistake, thereby ensuring the smoothness of the VR experience of the user and improving the VR usage experience of the user.

At Step 203, if it is determined that the preset condition of displaying the interactive component model is satisfied, by identifying the target object in the image information, display a virtual object model corresponding to the target object while the interactive component model is displayed in the virtual reality space.

The virtual object model may be dynamically displayed following the movement of the target object. In this embodiment, the movement of the target object in the image information may be mapped to the virtual reality space, such that the virtual object model of the target object can follow the target object to move. For example, by identifying an image of a hand of a user and displaying the interactive component model in the virtual reality space, a virtual hand image of the user is displayed. The virtual hand image can dynamically change and be displayed with hand movement information of the hand image of the user. For another example, by identifying an image of a handheld device of a user and displaying the interactive component model in the virtual reality space, a virtual handheld device image is displayed. The virtual handheld device image can dynamically change and be displayed with device movement information of the image of the handheld device of the user.

In this optional way, refer to the virtual object model (such as a virtual hand or a virtual handheld device) of the user in the virtual reality space, the user can do movements to complete clicking on the displayed interactive component models to select an interactive component model of a function required by the user. This facilitates a user to perform control and can improve the efficiency of performing VR control by a user.

To further facilitate a user to perform control and enhance the sense of science and technology, optionally, step 203 may specifically include: A spatial display position of the interactive component model is dynamically adjusted based on changes in a spatial position of the virtual object model, such that the interactive component model can follow the virtual object model to move and be displayed. For this optional mode, the spatial position of the virtual object model may be pre-bound to the spatial display position of the interactive component model, such that when the spatial position of the virtual object model changes, the interactive component model can follow the virtual object model to move and be displayed. For example, when the hand of the user moves, the virtual hand in the virtual reality space can follow the hand to move, and the displayed interactive component model can follow the hand to move too, such that it is convenient for the user to find a position of an interactive component model to be selected, thus accurately clicking and selecting the interactive component model.

For the sake of displaying convenience, optionally, step 203 may specifically include: The interactive component model is displayed in a preset range of the virtual object model. For example, during the displaying of the virtual hand, interactive component models in the form of a floating ball are displayed, and these floating balls may be displayed in a range of a region near the virtual hand, making it easier for the user to perform selection and control.

After the user awakens the displaying of the interactive component model, the processes shown in step 204 and step 206 may be specifically performed to achieve the interaction function required by the user.

At Step 204, by identifying a position of the target object and mapping the position into the virtual reality space, determine a spatial position of a corresponding first click sign.

At Step 205, if the spatial position of the first click sign matches a spatial position of a target interactive component model among the interactive component models, determine that the target interactive component model is the interactive component model selected by the user.

At Step 206, perform the interaction function event that is pre-bound to the target interactive component model.

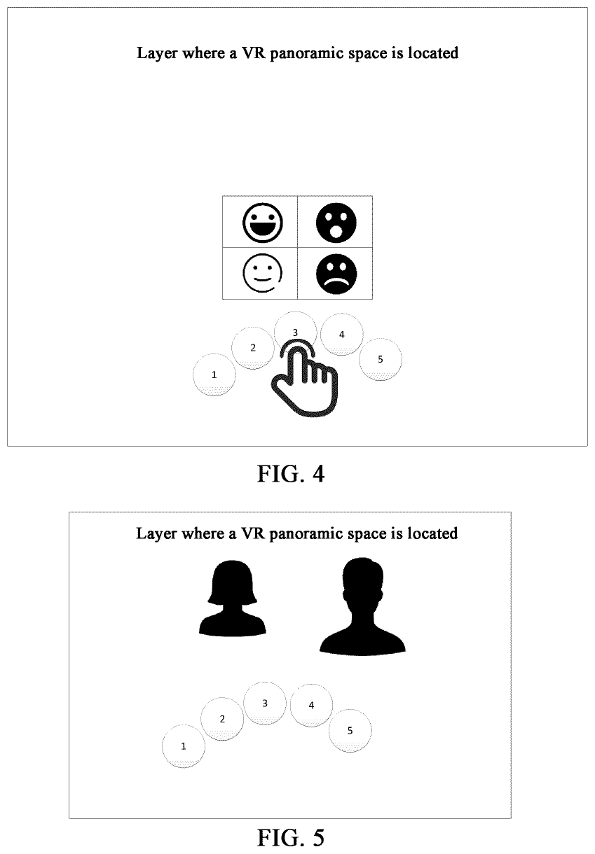

For example, as shown in FIG. 4, if a user raises the left hand, the virtual left hand of the user mapped into the virtual reality space enters a current field of view range of the user to awaken the displaying of the interactive component models in the form of a floating ball, and the user moves the right hand to select and click on an interactive component model among the interactive component models. On the VR device side, based on the image of the hand of the user, the position of the right hand of the user may be identified and mapped into the virtual reality space to determine the spatial position of the corresponding click sign. If the spatial position of the click sign matches the spatial position of the interactive component model of “sending an emoji”, the user selects and clicks on the “sending an emoji” function. Finally, the interaction function event pre-bound to the interactive component model of “sending an emoji” is performed. Namely, the function of sending an emoji is triggered to be called, thereby displaying an emoji panel model.

In practical applications, a function panel triggered to be displayed may include a plurality of options. To achieve further option control, optionally, step 206 may specifically include: First, an option panel model corresponding to the target interactive component model is displayed in the virtual reality space: by identifying a position of the target object, the position is mapped into the virtual reality space, and a spatial position of a corresponding second click sign is determined; and if the spatial position of the second click sign matches a spatial position of a target option in the option panel, it is determined that the target option is an option selected by the user in the option panel, and performing of a corresponding event is triggered.

For example, as shown in FIG. 4, after the function panel model of “sending an emoji” is displayed, there will be a plurality of emoji options on the function panel model, and the user can move the right hand to select and click on an emoji option among the plurality of emoji options. On the VR device side, based on the image of the hand of the user, the position of the right hand of the user may be identified and mapped into the virtual reality space to determine the spatial position of the corresponding click sign. If the spatial position of the click sign matches the spatial position of the emoji option of “scared”, the user selects and clicks on the emoji option of “scared”. Finally, the emoji “scared” is sent, such that an emoji style image of “scared” may be displayed above the head of the virtual character of the user.

The content of the above embodiments explains the specific processes of how to awaken the displaying of the interactive component model and how to click, select, and use the interactive component model. If the interactive component model does not need to be displayed, to facilitate the user to perform control, further optionally, after the at least one interactive component model is displayed in virtual reality space, the method of this embodiment may further include: Whether a preset condition (which may be preset according to an actual need) of canceling the displaying of the interactive component model is satisfied is determined according to the target object in the image information; and if it is determined that the preset condition of canceling the displaying of the interactive component model is satisfied, the displaying of the at least one interactive component model is canceled in the virtual reality space.

Exemplarily; whether a preset condition of canceling the displaying of the interactive component model is satisfied is determined according to the target object in the image information, which may specifically include: Whether the preset condition of canceling the displaying of the interactive component model is satisfied is determined based on user gesture information or position information of the handheld device in the image information. For example, the user raises the left hand within a range, such that the virtual left hand of the user mapped to the virtual reality space enters a current field of view range of the user to awaken the displaying of the interactive component models. When the user does not need to display these interactive component models, the user puts down the raised left hand, such that the virtual left hand of the user mapped to the virtual reality space is out of the current field of view range of the user, and the displaying of these interactive component models may be canceled. When the interactive component models need to be displayed, the user raises the left hand again.

To explain the specific implementation processes of the above various embodiments, the following application examples are provided using the method of this embodiment, but not limited to:

At present, based on a VR technology, a user can view virtual livestreaming videos and other video contents. For example, after wearing a VR device, a user can enter a virtual live concert and watch the performance, as if the user is in the live scene.

To meet a capturing need of the user when the user watches VR videos, based on the content of the method of this embodiment, the camera may be used to take images of the hand of the user or the handheld device of the user, and a gesture of the hand of the user or the position of the handheld device in the image is determined based on the image identification technology; and if it is determined that the hand of the user or the handheld device of the user is raised within a range to cause the virtual hand or virtual handheld device of the user mapped to the virtual reality space to enter the current field of view of the user, the displaying of the interactive component models may be awakened in the virtual reality space. As shown in FIG. 5, based on an image identification technology, a user can lift a handheld device to awaken interactive component models in the form of a floating ball. Each floating ball represents a control function. The user can interact with others based on the floating ball functions. As shown in FIG. 5, the interactive component models may specifically include: “leaving the room”, “taking pictures”, “sending an emoji”, “sending on-screen comments”, “2D livestreaming”, and the like.

After the interactive component models in the form of a floating ball are awakened, according to the subsequently monitored image of the hand of the user or the image of the handheld device of the user, by identifying the position of the hand of the user or the handheld device of the user, the position is mapped to the virtual reality space, and the spatial position of the corresponding click sign is determined. If the spatial position of the click sign matches the spatial position of the target interactive component model among these displayed interactive component models, it is determined that the target interactive component model is the interactive component model selected by the user. Finally, the interaction function event pre-bound to the target interactive component model is performed.

The user can raise a gamepad in the left hand to awaken the displaying of the interactive component models in the form of a floating ball, and then move the position of the gamepad in the right hand to select and click on an interactive component model among the interactive component models. On the VR device side, based on the image of the gamepad of the user, the position of the gamepad in the right hand may be identified and mapped into the virtual reality space to determine the spatial position of the corresponding click sign. If the spatial position of the click sign matches the spatial position of the interactive component model of “taking pictures”, the user selects and clicks on the “taking pictures” function. Finally, the interaction function event pre-bound to the interactive component model of “taking pictures” is performed. Namely, the function of taking pictures is triggered to be called. In virtual reality images, scenario information corresponding to a capturing range of a camera model is selected and is rendered to the texture. The camera model is displayed in the virtual reality space, and a rendered texture map is placed in a preset viewfinder region of the camera model.

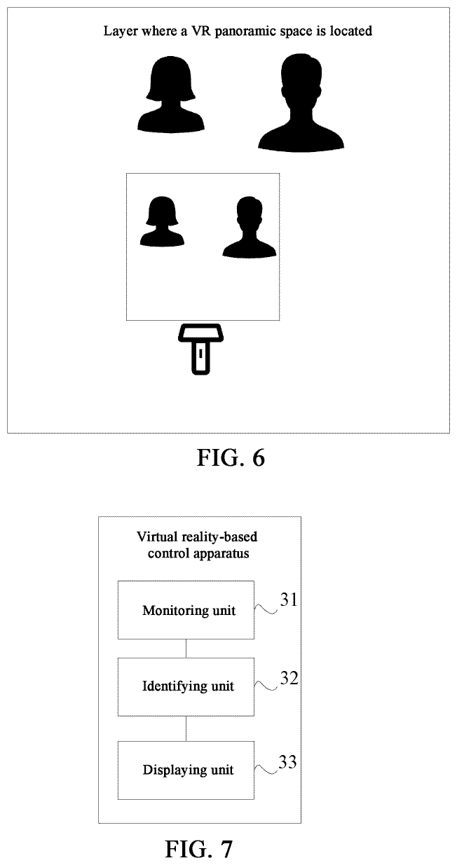

As shown in FIG. 6, after a user clicks on the floating ball of the “taking pictures” function, a corresponding capturing function panel may be displayed, and then a camera model in the form of a selfie stick camera is displayed in the virtual reality space; and a framed image is displayed in a viewfinder. If the user needs to take image information within a desired capturing range, the user can enter an adjustment instruction for capturing range to dynamically adjust the capturing range of the camera model.

Compared with an existing screen recording method, this virtual capturing method in the solution of this embodiment renders VR scenario information within a selected range in real time to the texture, and then pastes it to the viewfinder region, without the help of sensors such as a physical camera module, thus ensuring the quality of taken images. Furthermore, during the movement of the camera, the content of the VR scenario within the dynamic moving capturing range may be presented in real time in the preset viewfinder region, and the display effect of the framed image will not be affected by factors such as swinging of the camera. This can well simulate the real capturing feeling of the user, thereby improving the VR usage experience of the user. Compared with the method for triggering calling of a capturing function by using a button of a physical device, this embodiment can provide an improved solution for performing VR control without the help of a physical device, which can effectively improve the technical problem that user control is easily affected due to the button of the physical device being easily damaged.

Further, as a specific implementation of FIG. 1 and FIG. 2, this embodiment provides a virtual reality-based control apparatus. As shown in FIG. 7, the apparatus includes: a monitoring unit 31, an identifying unit 32, and a displaying unit 33.

The monitoring unit 31 is configured to monitor image information captured by a camera for a user. The identifying unit 32 is configured to identify movement information of a target object in the image information. The displaying unit 33 is configured to display, according to the movement information of the target object, at least one interactive component model in a virtual reality space, and perform an interaction function event that is pre-bound to an interactive component model selected by the user.

In a specific application scenario, optionally, the target object includes: a hand of the user. Correspondingly, the displaying unit 33 is specifically configured to: identify user gesture information in the image information: determine whether the user gesture information matches preset gesture information; and if the user gesture information matches the preset gesture information, display the at least one interactive component model in the virtual reality space.

In a specific application scenario, the displaying unit 33 is further specifically configured to: if a raising amplitude of the hand of the user is greater than a preset amplitude threshold, determine that the user gesture information matches the preset gesture information.

In a specific application scenario, optionally, the target object includes: a handheld device of the user. Correspondingly, the displaying unit 33 is specifically configured to: identify position information of the handheld device in the image information: determine whether the position information of the handheld device complies with a preset position change rule; and if the position information of the handheld device complies with the preset position change rule, display the at least one interactive component model in the virtual reality space.

In a specific application scenario, optionally, the displaying unit 33 is further specifically configured to: if a lifting amplitude of a handheld device is greater than a preset lifting threshold, determine that the position information of the handheld device complies with the preset position change rule.

In a specific application scenario, the displaying unit 33 is specifically configured to: display a virtual object model corresponding to the target object when displaying the interactive component model in the virtual reality space, wherein the virtual object model can follow the movement of the target object to dynamically change and be displayed.

In a specific application scenario, the displaying unit 33 is further specifically configured to: dynamically adjust a spatial display position of the interactive component model based on changes in a spatial position of the virtual object model, such that the interactive component model can follow the virtual object model to move and be displayed.

In a specific application scenario, the displaying unit 33 is further specifically configured to: display the interactive component model in a preset range of the virtual object model.

In a specific application scenario, the displaying unit 33 is further specifically configured to: by identifying a position of the target object, map the position into the virtual reality space, and determine a spatial position of a corresponding first click sign: if the spatial position of the first click sign matches a spatial position of a target interactive component model among the interactive component models, determine that the target interactive component model is the interactive component model selected by the user; and perform the interaction function event that is pre-bound to the target interactive component model.

In a specific application scenario, the displaying unit 33 is further specifically configured to: display an option panel model corresponding to the target interactive component model in the virtual reality space: by identifying a position of the target object, map the position into the virtual reality space, and determine a spatial position of a corresponding second click sign; and if the spatial position of the second click sign matches a spatial position of a target option in the option panel, determine that the target option is an option selected by the user in the option panel, and trigger performing of a corresponding event.

In a specific application scenario, the displaying unit 33 is further specifically configured to: after displaying at least one interactive component model in a virtual reality space, determine, according to the target object in the image information, whether a preset condition of canceling the displaying of the interactive component model is satisfied; and if it is determined that the preset condition of canceling the displaying of the interactive component model is satisfied, cancel the displaying of the at least one interactive component model in the virtual reality space.

In a specific application scenario, the displaying unit 33 is further specifically configured to: determine, based on user gesture information or position information of the handheld device in the image information, whether the preset condition of canceling the displaying of the interactive component model is satisfied.

It should be noted that other corresponding descriptions of the various functional units in the virtual reality-based control processing apparatus provided by this embodiment may be found in the corresponding descriptions in FIG. 1 and FIG. 2 and will not be elaborated here.

Based on the method shown in FIG. 1 and FIG. 2 above, correspondingly, this embodiment further provides a computer-readable medium, having a computer program stored thereon. The computer program, when run by a processor, implements the virtual reality-based control method shown in FIG. 1 and FIG. 2 above.

Based on this understanding, the technical solutions of the present disclosure can be embodied in the form of a software product. The software product can be stored in a non-volatile storage medium (such as a compact disc-read only memory (CD-ROM), a USB flash disk (U disk), and a portable hard disk drive), including several instructions used for causing a computer device (which can be a personal computer, a server, or a network device) to perform the methods of the various implementation scenarios of the present disclosure.

Based on the method shown in FIG. 1 and FIG. 2 above and the virtual apparatus embodiment shown in FIG. 7, to achieve the above objectives, the embodiments of the present disclosure further provide an electronic device, which can be specifically a virtual reality device, such as a VR head-mounted device. The device includes a storage medium and a processor. The storage medium is configured to store a computer program; and the processor is configured to run the computer program to implement the virtual reality-based control method shown in FIG. 1 and FIG. 2 above.

Optionally, the above physical device can further include a user interface, a network interface, a camera, a radio frequency (RF) circuit, a sensor, an audio circuit, a WI-FI module, and the like. The user interface may include a display and an input unit such as a keyboard. Optionally, the user interface may further include a USB interface, a card reader interface, and the like. Optional, the network interface can include a standard wired interface, a wireless interface (such as a WI-FI interface), and the like.

Those skilled in the art can understand that the above physical device structure provided by this embodiment does not constitute a limitation on the physical device, and may include more or fewer components, or combinations of some components, or different component arrangements.

The storage medium may further include an operating system and a network communication module. The operating system is a program that manages hardware and software resources of the aforementioned physical device, and supports running of information processing programs and other software and/or programs. The network communication module is configured to achieve communications between various components in the storage medium, as well as communications with other hardware and software in an information processing physical device.

Through the description of the above implementations, those skilled in the art can clearly understand that the present disclosure can be implemented by relying on software and essential general-purpose hardware platforms, or by relying on hardware. By applying the solutions of this embodiment, the technical problem that user control is easily affected due to the button of the physical device being easily damaged can be effectively improved. A stronger technological sense can be brought to users, thereby enhancing the VR usage experience of the users.

It should be noted that in this document, relationship terms such as “first” and “second” are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an . . . ” does not exclude the presence of another identical elements in the process, method, article or device that includes the element.

The above only describes the specific implementations of the present disclosure, which enables those skilled in the art to understand or implement the present disclosure. The various modifications to these embodiments will be apparent to those skilled in the art, and the general principles defined herein can be implemented in other embodiments without departing from the spirit or scope of the present disclosure. Thus, the present disclosure is not limited to these embodiments shown herein, but accords with the broadest scope consistent with the principles and novel features disclosed herein.

1. A virtual reality-based control method, comprising:
monitoring image information captured by a camera for a user;
identifying movement information of a target object in the image information; and
displaying, according to the movement information of the target object, at least one interactive component model in a virtual reality space, and performing an interaction function event that is pre-bound to an interactive component model selected by the user.

2. The method of claim 1, wherein the target object comprises a hand of the user; and displaying, according to the movement information of the target object, at least one interactive component model in a virtual reality space comprises:
identifying user gesture information in the image information;
determining whether the user gesture information matches preset gesture information; and
displaying, in a case that the user gesture information matches the preset gesture information, the at least one interactive component model in the virtual reality space.

3. The method of claim 2, wherein determining whether the user gesture information matches preset gesture information comprises:
in a case that a raising range of the hand of the user is greater than a preset range threshold, determining that the user gesture information matches the preset gesture information.

4. The method of claim 1, wherein the target object comprises: a handheld device of the user; and displaying, according to the movement information of the target object, at least one interactive component model in a virtual reality space comprises:
identifying position information of the handheld device in the image information;
determining whether the position information of the handheld device complies with a preset position change rule; and
in a case that the position information of the handheld device complies with the preset position change rule, displaying the at least one interactive component model in the virtual reality space.

5. The method of claim 4, wherein determining whether the position information of the handheld device complies with a preset position change rule comprises:
in a case that a lifting amplitude of the handheld device is greater than a preset amplitude threshold, determining that the position information of the handheld device complies with the preset position change rule.

6. The method of claim 1, wherein displaying, according to the movement information of the target object, at least one interactive component model in a virtual reality space comprises:
displaying a virtual object model corresponding to the target object while displaying the interactive component model in the virtual reality space, wherein the virtual object model is dynamically displayed following the movement of the target object.

7. The method of claim 6, wherein by identifying the target object in the image information, displaying a virtual object model corresponding to the target object while displaying the interactive component model in the virtual reality space comprises:
dynamically adjusting a spatial display position of the interactive component model based on a change in a spatial position of the virtual object model, such that the interactive component model follows the virtual object model to move and be displayed.

8. The method of claim 6, wherein by identifying the target object in the image information, displaying a virtual object model corresponding to the target object while displaying the interactive component model in the virtual reality space comprises:
displaying the interactive component model in a preset range of the virtual object model.

9. The method of claim 1, wherein displaying, according to the movement information of the target object, at least one interactive component model in a virtual reality space, and performing an interaction function event that is pre-bound to an interactive component model selected by the user comprise:
determining, by identifying a position of the target object and mapping the position into the virtual reality space, a spatial position of a corresponding first click sign;
in a case that the spatial position of the first click sign matches a spatial position of a target interactive component model among the interactive component models, determining that the target interactive component model is the interactive component model selected by the user; and
performing the interaction function event that is pre-bound to the target interactive component model.

10. The method of claim 9, wherein performing the interaction function event that is pre-bound to the target interactive component model comprises:
displaying an option panel model corresponding to the target interactive component model in the virtual reality space;
determining, by identifying a position of the target object and mapping the position into the virtual reality space, a spatial position of a corresponding second click sign; and
in a case that the spatial position of the second click sign matches a spatial position of a target option in the option panel, determining that the target option is an option selected by the user in the option panel, and triggering performing of a corresponding event.

11. The method of claim 1, wherein the method further comprises, after displaying at least one interactive component model in a virtual reality space:
determining, according to the target object in the image information, whether a preset condition of canceling displaying of the interactive component model is satisfied; and
in a case that the preset condition of canceling displaying of the interactive component model is satisfied, canceling the displaying of the at least one interactive component model in the virtual reality space.

12. The method of claim 11, wherein determining, according to the target object in the image information, whether a preset condition of canceling the displaying of the interactive component model is satisfied comprises:
determining, based on user gesture information or position information of the handheld device in the image information, whether the preset condition of canceling the displaying of the interactive component model is satisfied.

13. (canceled)

14. A non-transitory computer-readable storage medium having a computer program stored thereon, wherein the computer program, when run by a processor, implements a method comprising:
monitoring image information captured by a camera for a user;
identifying movement information of a target object in the image information; and
displaying, according to the movement information of the target object, at least one interactive component model in a virtual reality space, and performing an interaction function event that is pre-bound to an interactive component model selected by the user.

15. An electronic device comprising a storage medium, a processor, and a computer program stored on the storage medium and runnable on the processor, wherein the processor, when running the computer program, implements a method of comprising:
monitoring image information captured by a camera for a user;
identifying movement information of a target object in the image information; and
displaying, according to the movement information of the target object, at least one interactive component model in a virtual reality space, and performing an interaction function event that is pre-bound to an interactive component model selected by the user.

16. The electronic device of claim 15, wherein the target object comprises a hand of the user; and displaying, according to the movement information of the target object, at least one interactive component model in a virtual reality space comprises:
identifying user gesture information in the image information;
determining whether the user gesture information matches preset gesture information; and
displaying, in a case that the user gesture information matches the preset gesture information, the at least one interactive component model in the virtual reality space.

17. The electronic device of claim 16, wherein determining whether the user gesture information matches preset gesture information comprises:
in a case that a raising range of the hand of the user is greater than a preset range threshold, determining that the user gesture information matches the preset gesture information.

18. The electronic device of claim 15, wherein the target object comprises a handheld device of the user; and displaying, according to the movement information of the target object, at least one interactive component model in a virtual reality space comprises:
identifying position information of the handheld device in the image information;
determining whether the position information of the handheld device complies with a preset position change rule; and
in a case that the position information of the handheld device complies with the preset position change rule, displaying the at least one interactive component model in the virtual reality space.

19. The electronic device of claim 18, wherein determining whether the position information of the handheld device complies with a preset position change rule comprises:
in a case that a lifting amplitude of the handheld device is greater than a preset amplitude threshold, determining that the position information of the handheld device complies with the preset position change rule.

20. The electronic device of claim 16, wherein displaying, according to the movement information of the target object, at least one interactive component model in a virtual reality space comprises:
displaying a virtual object model corresponding to the target object while displaying the interactive component model in the virtual reality space, wherein the virtual object model is dynamically displayed following the movement of the target object.

21. The electronic device of claim 20, wherein by identifying the target object in the image information, displaying a virtual object model corresponding to the target object while displaying the interactive component model in the virtual reality space comprises:
dynamically adjusting a spatial display position of the interactive component model based on a change in a spatial position of the virtual object model, such that the interactive component model follows the virtual object model to move and be displayed.
